(19) United States
(12) Patent Application Publication
(10) Pub. No.: US 2026/0188578 A1
(43) Pub. Date: Jul. 2, 2026

(54) MULTILAYER ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Taek Jung LEE, Suwon-si (KR); Hai Joon LEE, Suwon-si (KR)

(73) Assignee: SAMSUNG ELECTRO-MECHANICS CO., LTD., Suwon-si (KR)

(21) Appl. No.: 19/372,206

(22) Filed: Oct. 28, 2025

(30) Foreign Application Priority Data
Dec. 26, 2024 (KR) 10-2024-0197742

(51) Int. Cl. H01G 4/012; H01G 4/008; H01G 4/12; H01G 4/30

(52) U.S. Cl. CPC H01G 4/012; H01G 4/008; H01G 4/12; H01G 4/30

(57) ABSTRACT

A multilayer electronic component includes a body including a dielectric layer, and two or more internal electrodes alternately disposed with the dielectric layer in a first direction and having different lengths in a second direction, perpendicular to the first direction; and an external electrode disposed on the body and connected to at least one of the internal electrodes, wherein the internal electrodes include a main electrode pair that is connected to the external electrodes and disposed with the dielectric layer therebetween, and an auxiliary electrode pair spaced apart from the outer electrode in the second direction and disposed with the dielectric layer therebetween, where the internal electrodes may have a continuous shape in the second direction.

### CROSS-REFERENCE TO RELATED APPLICATION(S)

This application claims benefit of priority to Korean Patent Application No. 10-2024-0197742 filed on Dec. 26, 2024 in the Korean Intellectual Property Office, the disclosure of which is incorporated herein by reference in its entirety.

### TECHNICAL FIELD

The present disclosure relates to a multilayer electronic component and a method of manufacturing the same.

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, onboard charger (OBC), DC-DC converter for electric vehicles, or the like, and serves to charge or discharge electricity therein or therefrom.

In order to implement various capacitances in the same size of MLCCs, design changes such as dielectric sheets or internal electrode specifications, or the like may be required, and these design changes may cause increasing the time required to complete the MLCC. In particular, for MLCCs requiring precise tolerances and narrow electrical characteristic variations, an additional process for evaluating capacitance may be performed in an intermediate process before an entire product is made, which may take more time to complete a final MLCC product.

Therefore, there is a need for improvement in a method that may implement various capacitances within substantially the same size and improve production efficiency of MLCCs without a process of evaluating the capacitance in the middle of MLCC manufacturing, and at the same time, structural improvement that may secure mechanical strength of MLCCs is required.

### SUMMARY

An aspect of the present disclosure is to provide a multilayer electronic component capable of implementing various capacitances.

An aspect of the present disclosure is to provide a multilayer electronic component having improved mechanical strength.

An aspect of the present disclosure is to provide a method for manufacturing a multilayer electronic component without a need for a separate capacitance evaluation process in the middle of a manufacturing process.

However, problems to be solved by the present disclosure are not limited to the above, and will be more easily understood in the process of describing specific embodiments of the present disclosure.

A multilayer electronic component according to an embodiment may comprise: a body including dielectric layers, and two or more internal electrodes alternately disposed with the dielectric layers in a first direction and having different lengths in a second direction, perpendicular to the first direction; and an external electrode disposed on the body and connected to one or more of the internal electrodes, wherein the internal electrodes may include a main electrode pair connected to the external electrodes and disposed with the dielectric layer therebetween, and an auxiliary electrode pair spaced apart from the external electrodes in the second direction and disposed with the dielectric layer therebetween, and the internal electrodes may have a continuous shape in the second direction.

A method for manufacturing a multilayer electronic component according to an embodiment may comprise: forming a body including dielectric layers, and two or more internal electrodes alternately disposed with the dielectric layers in the first direction and having different lengths in the second direction, perpendicular to the first direction; and forming external electrodes disposed on the body and connected to one or more of the internal electrodes, wherein the internal electrodes may include the main electrode pair disposed with the dielectric layer therebetween and connected to the external electrodes, and the auxiliary electrode pair spaced apart from the external electrodes in the second direction and disposed with the dielectric layer therebetween, wherein the internal electrodes may have a continuous shape in the second direction, and the main electrode pair and the auxiliary electrode pair may be formed by polishing opposing surfaces of a multilayer electronic component in the second direction in which dielectric sheets and internal electrode sheets are stacked.

According to an aspect of the present disclosure, a multilayer electronic component capable of implementing various capacitances may be provided.

According to an aspect of the present disclosure, the multilayer electronic component with improved mechanical strength may be provided.

According to an aspect of the present disclosure, a method for manufacturing a multilayer electronic component without a need for a separate capacitance evaluation process in the middle of a manufacturing process may be provided.

However, the purpose of the present disclosure is not limited to the above-described content, and may be more easily understood in the process of explaining specific embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment.

FIG. 2 schematically illustrates cross-sectional views of a multilayer electronic component in the first and second directions according to a conventional embodiment.

FIG. 3 schematically illustrates cross-sectional views of the multilayer electronic component in the first and second directions according to a conventional embodiment.

FIG. 4 schematically illustrates cross-sectional views of the multilayer electronic component in the first and third direction according to an embodiment.

FIG. 5 schematically illustrates cross-sectional views of the multilayer electronic component in the first and second direction according to an embodiment.

FIG. 6 schematically illustrates cross-sectional views of the multilayer electronic component in the first and second direction according to an embodiment.

FIG. 7 is an enlarged view of a P region of FIG. 6.

FIG. 8 schematically illustrates a portion of a method for manufacturing the multilayer electronic component according to an embodiment.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawing, an X-direction may be defined as a direction in which a first and second internal electrodes may be alternately disposed with the dielectric layer therebetween, or among an Y-direction and a Z-direction, which are directions perpendicular to the first direction, the Y-direction may be defined as a second direction, and the Z-direction may be defined as a third direction.

### Multilayer Electronic Component

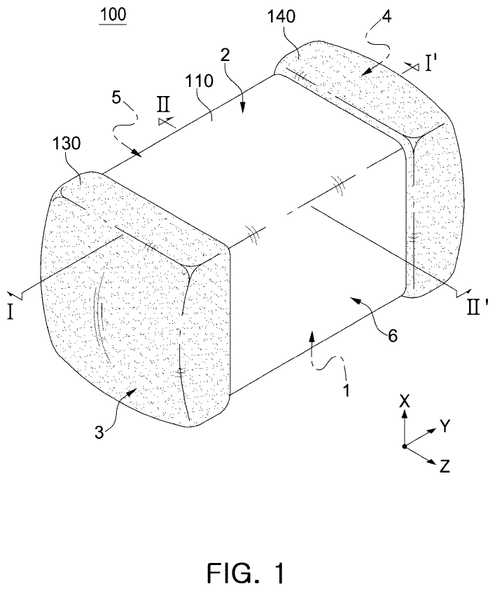

FIG. 1 schematically illustrates a perspective view of a multilayer electronic component according to an embodiment.

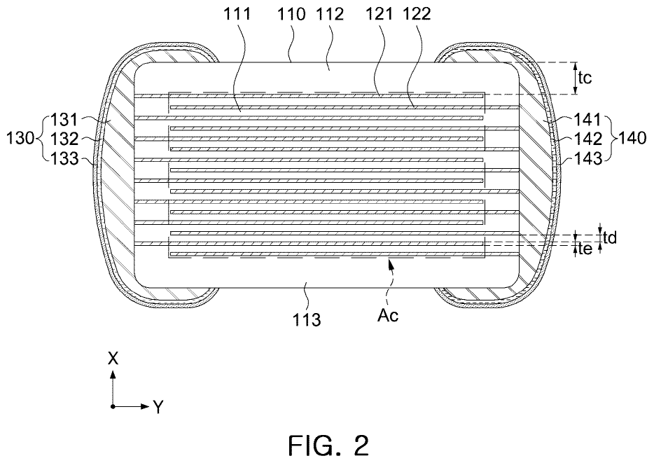

FIG. 2 schematically illustrates cross-sectional views of a multilayer electronic component in the first and second directions according to a conventional embodiment.

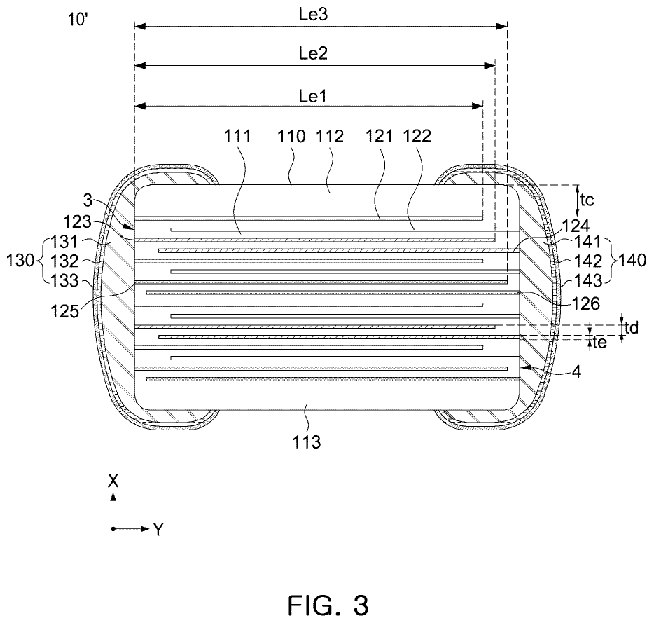

FIG. 3 schematically illustrates cross-sectional views of the multilayer electronic component in the first and second directions according to a conventional embodiment.

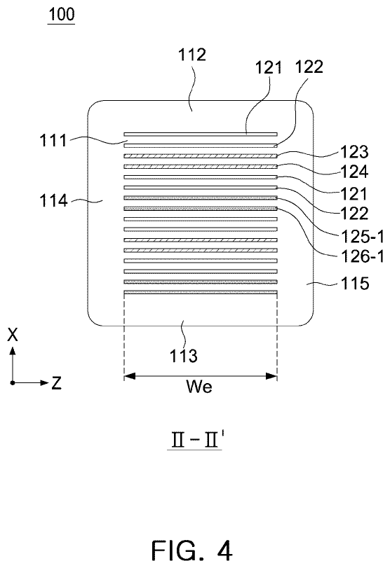

FIG. 4 schematically illustrates cross-sectional views of the multilayer electronic component in the first and third direction according to an embodiment.

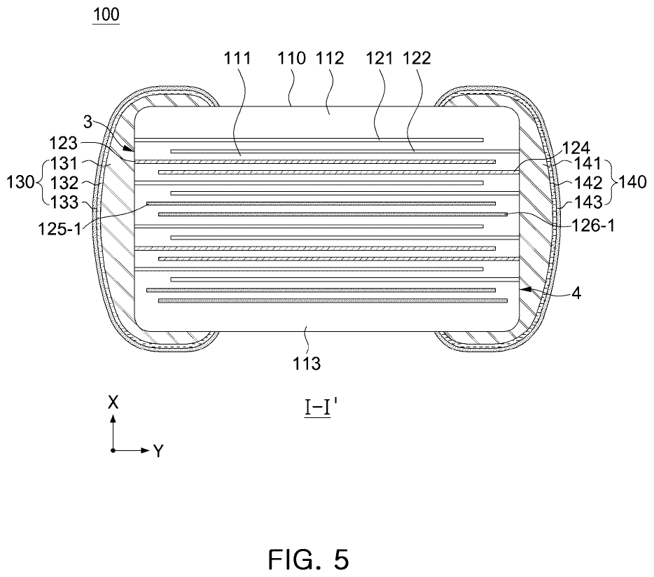

FIG. 5 schematically illustrates cross-sectional views of the multilayer electronic component in the first and second direction according to an embodiment.

Hereinafter, a multilayer electronic component 100 according to an embodiment will be described in detail with reference to FIGS. 1 to 5.

According to an embodiment, a multilayer electronic component 100 comprises: a body 110 including a dielectric layer 111, two or more internal electrodes 121, 122, 123, 124, 125-1, and 126-1 alternately disposed with the dielectric layer 111 in the first direction and having different lengths in the second direction, perpendicular to the first direction, external electrodes 130 and 140 disposed on the body 110 and connected to one or more of internal electrodes 121, 122, 123, 124, 125-1, and 126-1, wherein the internal electrodes 121, 122, 123, 124, 125-1, and 126-1 may include main electrode pairs 121, 122, 123 and 124 connected to the external electrodes 130 and 140, and disposed with the dielectric layer 111 therebetween and auxiliary electrode pairs 125-1 and 126-1 spaced apart from the external electrodes 130 and 140 in the second direction and disposed with a dielectric layer 111 therebetween, wherein the internal electrodes 121, 122, 123, 124, 125-1, and 126-1 may have a continuous shape in the second direction.

Referring to FIG. 5, the body 110 may include a dielectric layer 111, and internal electrodes 121, 122, 123, 124, 125-1, and 126-1 alternately disposed with the dielectric layer 111 in the first direction.

The body 110 is not limited to a particular shape, and may have a hexahedral shape or a shape similar thereto, as illustrated in the drawings. The body 110 may not have a hexahedral shape having perfectly straight lines because ceramic powder particles included in the body 110 may contract in a process in which the body is sintered, however, the body 110 may have a substantially hexahedral shape.

Referring to FIG. 1, the body 110 may include first and second surfaces 1 and 2 opposing each other in the first direction, third and fourth surfaces 3 and 4 opposing each other in a second direction, perpendicular to the first direction, and fifth and sixth surfaces 5 and 6 opposing each other in a third direction perpendicular to the first and second direction.

A plurality of dielectric layers 111 forming the body 110 may be in a sintered state, and adjacent dielectric layers 111 may be integrated with each other, such that boundaries therebetween may not be readily apparent without a scanning electron microscope SEM. The number of stacked dielectric layers is not particularly limited and it may be determined in consideration of a size of a ceramic electronic component. For example, a body may be formed by stacking 300 or more dielectric layers.

A main component of the dielectric composition forming the dielectric layer 111 is not particularly limited, as long as sufficient electrostatic capacitance may be obtained. For example, the dielectric layer 111 may include a perovskite-typed compound represented by ABO₃ as a main component. The perovskite-typed compound represented by ABO3 may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃ and ((Ca₁₋ₓSrₓ)(Zr_{1-y}Ti_{y})O₃ (0<x≤0.5, 0<y≤0.5).

As illustrated in FIG. 5, the body 110 according to an embodiment may include the dielectric layer 111 and two or more of the internal electrodes 121, 122, 123, 124, 125-1, and 126-1 alternately disposed in the first direction and having different lengths in the second direction.

Referring to FIG. 2, the internal electrodes 121 and 122 included in a multilayer electronic component 10 according to the conventional embodiment may have substantially the same length in the second direction. In this case, in order to implement various capacitances of the multilayer electronic component 10, specifications of one or more of the dielectric layer 111 and the internal electrodes 121 and 122 have to be changed through a separate design, and accordingly, it may take a considerable amount of time to complete the multilayer electronic component 10. In particular, in case of multilayer electronic products requiring precise tolerances and narrow electrical characteristic variations, it may take more time to complete the multilayer electronic component 10 since an additional process of evaluating capacitance may be performed in an intermediate process before an entire product is manufactured.

Referring to FIG. 3, a multilayer electronic component 10′ according to a conventional embodiment may include two or more of internal electrodes 121, 122, 123, 124, 125, and 126 having different lengths Le1, Le2, and Le3 in the second direction, and through this, the multilayer electronic component 10′ having various capacitances may be implemented without separate design changes to the dielectric layer 111 or the internal electrodes 121, 122, 123, 124, 125, and 126. However, as in the multilayer electronic component 10′ according to a conventional embodiment, when two or more of internal electrodes 121, 122, 123, 124, 125, and 126 having different lengths Le1, Le2, and Le3 in the second direction are all connected to the external electrodes 130 and 140, stress generated during a sintering process of the body 110 may not be effectively distributed due to asymmetry in a shapes of the internal electrodes 121, 122, 123, 124, 125, and 126, and thus mechanical strength of the multilayer electronic component 10′ may be reduced.

Accordingly, in the multilayer electronic component 100 according to an embodiment of the present disclosure, the internal electrodes 121, 122, 123, 124, 125-1, and 126-1 may include the main electrode pairs 121, 122, 123, and 124 in which two or more of internal electrodes having different lengths in the second direction may be connected to external electrodes 130 and 140 to be described later and disposed with the dielectric layer 111 therebetween, and the auxiliary electrode pairs 125-1 and 126-1 spaced apart from the external electrodes 130 and 140 and with the dielectric layer 111 therebetween, thereby enabling implementation of various capacitances in a multilayer electronic component having substantially the same size without an additional process, and preventing a problem of the mechanical strength of the multilayer electronic component being reduced by forming the internal electrodes having different lengths.

Referring to FIG. 5, the main electrode pairs 121, 122, 123, and 124 may be connected to external electrodes 130 and 140 to be described later and contribute to form an electrostatic capacitance of the multilayer electronic component 100. The main electrode pairs 121, 122, 123, and 124 may include first internal electrodes 121 and 123 connected to a first external electrode 130 to be described later, and second internal electrodes 122 and 124 connected to a second external electrode 140.

The main electrode pairs 121, 122, 123 and 124 may include a plurality of electrode pairs in which the first internal electrodes 121 and 123 and the second internal electrodes 122 and 124 may be disposed with the dielectric layer 111 therebetween, and lengths of the first internal electrodes 121 and 123 in the second direction included in each electrode pair may be different, and the lengths of the second internal electrodes 122 and 124 in the second direction included in each electrode pair may be different.

Referring to FIG. 5, the auxiliary electrode pairs 125-1 and 126-1 may be spaced apart from the external electrodes 130 and 140 described later to improve the mechanical strength of the multilayer electronic component 100. The auxiliary electrode pairs 125-1 and 126-1 may include a first auxiliary electrode 125-1 disposed closer to the first external electrode 130 than the second external electrode 140 and a second auxiliary electrode 126-1 disposed closer to the second external electrode 140 than the first external electrode 130.

According to an embodiment, the internal electrodes 121, 122, 123, 124, 125-1, and 126-1 may have a continuous shape in the second direction. In this case, the meaning of “continuous shape” may mean that the internal electrodes 121, 122, 123, 124, 125-1, and 126-1 are formed as an integral body without being separated in the second direction, and may not mean that it does not include voids or microscopic gaps that may be formed when the internal electrodes are formed.

Meanwhile, the auxiliary electrode pairs 125-1 and 126-1 may be formed by sintering an internal electrode paste having length in the second direction longer than that of the internal electrode paste for forming the main electrode pairs 121, 122, 123, and 124. Accordingly, an area overlapping the main electrode pairs 121, 122, 123, and 124 to each other in the first direction according to an embodiment may be smaller than an area overlapping the auxiliary electrode pairs 125-1 and 126-1 to each other in the first direction.

Materials forming the internal electrodes 121, 122, 123, 124, 125-1, and 126-1 are not particularly limited, and materials having excellent electrical conductivity may be used. For example, the internal electrodes 121 and 122 may be formed by printing a conductive paste for internal electrodes containing one or more of nickel (Ni), copper (Cu), palladium (Pd), silver (Ag), gold (Au), platinum (Pt), tin (Sn), tungsten (W), titanium (Ti), and alloys thereof on a dielectric sheet. The printing method for the conductive paste for the internal electrodes may use a screen printing method or a gravure printing method, but the present disclosure is not limited thereto.

Referring to FIG. 5, cover portions 112 and 113 may be disposed on an upper and lower portions of the internal electrodes 121, 122, 123, 124, 125-1, and 126-1 disposed at the outermost side in the first direction.

The cover portions 112 and 113 may be formed by stacking a single dielectric layer or two or more dielectric layers on the upper and lower portions of the internal electrodes 121, 122, 123, 124, 125-1, and 126-1 disposed at the outermost side of a capacitance in the first direction, and may basically contribute to prevent damage to the internal electrodes due to physical or chemical stress.

The cover portions 112 and 113 may not include the internal electrode, and may include the same material as that of the dielectric layer 111. That is, the cover portions 112 and 113 may include a ceramic material, for example, a barium titanate (BaTiO₃)-based ceramic material.

Meanwhile, an average thickness of the cover portions 112 and 113 is not particularly limited. However, in order to more easily achieve miniaturization and high capacitance of the multilayer electronic component, the average thickness tc of the cover portions 112 and 113 may be 15 μm or less.

The average thickness of the cover portions 112 and 113 may refer to a size in the first direction, and may be an average value of the size of the cover portions 112 and 113 in the first direction measured at 5 equally spaced apart points in the second direction.

Referring to FIG. 4, margin portions 114 and 115 may be disposed on both side surfaces of the internal electrodes 121, 122, 123, 124, 125-1, and 126-1 in the third direction.

The margin portions 114 and 115 may include a margin portion 114 disposed on the fifth surface 5 of the body 110 and a margin portion 115 disposed on the sixth surface 6 thereof. That is, the margin portions 114 and 115 may be a region in contact with both end surfaces of the body 110 in the third direction (width direction).

As illustrated in FIG. 3, the margin portions 114 and 115 may refer to a region between both ends of the internal electrodes 121, 122, 123, 124, 125-1, and 126-1 and a boundary surface of the body 110 in a cross-section of the body 110 cut in the first and third directions.

The margin portions 114 and 115 may basically contribute to prevent damage to the internal electrode due to physical or chemical stresses.

The margin portions 114 and 115 may be formed by forming the internal electrodes by applying a conductive paste onto a ceramic green sheet, except for a region where the margin portion is to be formed.

In addition, to suppress a step difference caused by the internal electrodes 121, 122, 123, 124, 125-1, and 126-1, after stacking, the internal electrodes 121, 122, 123, 124, 125-1, and 126-1 may be cut so that they are exposed to the fifth and sixth surfaces 5 and 6 of the body 110, and then a single dielectric layer or two or more dielectric layers may be stacked on both side surfaces of the body 110 in the third direction to form the margin portions 114 and 115.

Meanwhile, a width of the margins 114 and 115 is not particularly limited. However, in order to more easily achieve miniaturization and high capacitance of the multilayer electronic component, an average width of the margin portions 114 and 115 may be 15 μm or less.

The average width of the margin portions 114 and 115 may refer to an average size of the margin portions 114 and 115 in the third direction, and may be an average value of a size of the margin portions 114 and 115 in the third direction measured at 5 points equally spaced apart in the first direction.

Referring to FIG. 1, the external electrodes 130 and 140 may be disposed on the body 110.

Specifically, when a direction perpendicular to the first direction is referred to as the second direction, the external electrodes 130 and 140 may be disposed on one side and the other side 3 and 4 of the body 110 opposing each other in the second direction.

In this case, the external electrode 130, 140 may include the first external electrode 130 disposed on one surface 3 of surfaces of the body 110 opposing each other in the second direction and connected to one or more of the internal electrodes 121, 122, 123, 124, 125-1, and 126-1, and the second external electrode 140 disposed on the other surface 4 of surfaces of the body 110 opposing each other in the second direction and connected to one or more of the internal electrodes 121, 122, 123, 124, 125-1, and 126-1.

In the embodiment, a structure in which a ceramic electronic component 100 has two external electrodes 130 and 140 is described, but the numbers or shapes of the external electrodes may be changed depending on a shape of the internal electrodes 121, 122, 123, 124, 125-1, and 126-1 or other purposes.

Meanwhile, the external electrodes 130 and 140 may be formed by using any materials that have electrical conductivity, such as a metal, and a specific material may be determined by considering electrical characteristics, structural stability, or the like, and further, may have a multilayer structure.

For example, the external electrodes 130 and 140 may include electrode layers 131 and 141 disposed on the body 110 and plating layers 132, 133, 142, and 143 formed on the electrode layers 131 and 141.

For a more specific example of the electrode layers 131 and 141, the electrode layers may be a sintered electrodes including a conductive metal and a glass, or a resin-based electrode including a conductive metal and a resin.

In addition, the electrode layer may have a form in which the sintered electrode and the resin-based electrode are sequentially formed on the body 110. Additionally, the electrode layers may be formed by transferring a sheet including the conductive metal onto the body 110, or may be formed by transferring the sheet including the conductive metal onto the sintered electrode.

A material having excellent electrical conductivity may be used as the conductive metal included in the electrode layers, but is not particularly limited thereto. For example, the conductive metal may be one or more of nickel (Ni), copper (Cu), palladium (Pd), silver (Ag), gold (Au), platinum (Pt), tin (Sn), tungsten (W), titanium (Ti), and alloys thereof.

The plating layers 132, 133, 142, and 143 may be plating layers including one or more of nickel (Ni), tin (Sn), palladium (Pd), and alloys thereof, and may be formed of a plurality of layers.

For more specific examples of the plating layers 132, 133, 142, and 143, the plating layer may be a Ni plating layer or a Sn plating layer, and may be in a form in which a Ni plating layer and a Sn plating layer are sequentially formed on the electrode layer, or may be in a form in which a Sn plating layer, a Ni plating layer, and a Sn plating layer are sequentially formed. Additionally, the plating layer may include a plurality of Ni plating layers and/or a plurality of Sn plating layers.

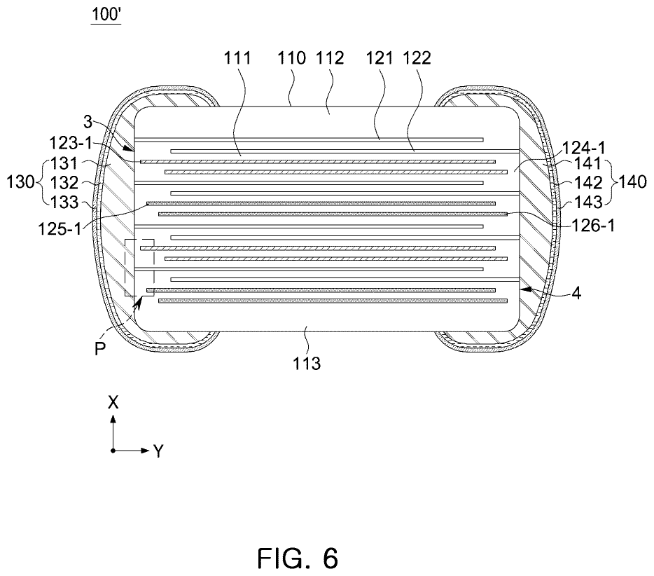

FIG. 6 schematically illustrates cross-sectional views of a multilayer electronic component in the first and second directions according to a modified example.

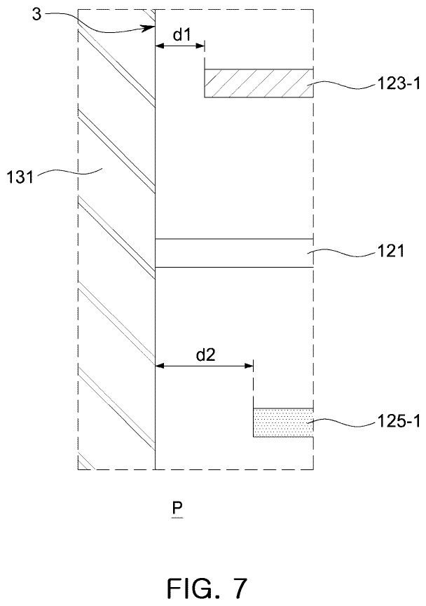

FIG. 7 is an enlarged view of region P of FIG. 6.

Hereinafter, a multilayer electronic component 100′ according to a modified example will be described in detail with reference to FIGS. 6 and 7, but the same content as the multilayer electronic component 100 according to an embodiment will be omitted.

Referring to FIG. 6, the internal electrodes 121, 122, 123-1, 124-1, 125-1, and 126-1 of the multilayer electronic component 100′ according to the modified example include two or more pairs of auxiliary electrode pairs 123-1, 124-1, 125-1, and 126-1, and the two or more pairs of auxiliary electrode pairs 123-1, 124-1, 125-1, and 126-1 may have different distances from adjacent external electrodes 130 and 140.

In FIG. 6, two or more pairs of auxiliary electrode pairs 123-1, 124-1, 125-1, and 126-1 according to a modified example are disclosed to include first auxiliary electrode pairs 123-1 and 124-1 and second auxiliary electrode pairs 125-1 and 126-1, but the auxiliary electrode pairs 123-1, 124-1, 125-1, and 126-1 of the present disclosure may include two or more pairs of auxiliary electrode pairs.

The first auxiliary electrode pairs 123-1 and 124-1 and the second auxiliary electrode pairs 125-1 and 126-1 may have different distances in the second direction, spaced apart from the external electrodes 130 and 140 closer to them among the external electrodes 130 and 140, and accordingly, the various capacitances of the multilayer electronic component 100′ may be implemented more efficiently, and at the same time, an effect of improving the mechanical strength of the multilayer electronic component 100′ may be further improved.

Referring to FIG. 7, when a distance that a 1-1 auxiliary electrode 123-1 of the first auxiliary electrode pair is spaced apart from the first electrode layer 131 of the first external electrode in the second direction is d1, and a distance that a 2-1 auxiliary electrode 125-1 of the second auxiliary electrode pair is spaced apart from the first electrode layer 131 of the first external electrode in the second direction is d2, an absolute value of the difference between d1 and d2 may be 1 μm or greater. Accordingly, an effect of implementing various capacitances of the multilayer electronic component 100′ may be further improved. Meanwhile, an upper limit of the absolute value of the difference between d1 and d2 is not particularly limited, but in order to implement various capacitances in practically the same size, the absolute value of the difference between d1 and d2 may be 5 μm or less.

Referring to FIG. 6, the main electrode pairs 121 and 122 may be disposed repeatedly in the first direction, and accordingly, the internal electrodes 121, 122, 123-1, 124-1, 125-1, and 126-1 may include two or more pairs of the main electrode pairs 121 and 122. Additionally, the auxiliary electrode pairs 123-1, 124-1, 125-1, and 126-1 may be disposed repeatedly in the first direction, and accordingly, the internal electrodes 121, 122, 123-1, 124-1, 125-1, and 126-1 may include two or more pairs of the auxiliary electrode pairs 123-1, 124-1, 125-1, and 126-1. In this case, each of the auxiliary electrode pairs 123-1, 124-1, 125-1, and 126-1 may be alternately disposed with the main electrode pairs 121 and 122 with the dielectric layer 111 therebetween.

An arrangement order of the main electrode pairs 121 and 122 and the auxiliary electrode pairs 123-1, 124-1, 125-1, and 126-1 in the first direction may vary. Specifically, the main electrode pairs 121 and 122 and the auxiliary electrode pairs 123-1, 124-1, 125-1, and 126-1 may be disposed in the first direction in a certain order.

In an embodiment, when an arrangement of the main electrode pairs 121 and 122 is A1, an arrangement 123-1 and 124-1 among the auxiliary electrode pairs 123-1, 124-1, 125-1, and 126-1 having a minimum separation distance from adjacent external electrodes is A2, and an arrangement 125-1 and 126-1 among the auxiliary electrode pairs 123-1, 124-1, 125-1, and 126-1 having a maximum separation distance from adjacent external electrodes is A3, the internal electrodes 121, 122, 123-1, 124-1, 125-1, and 126-1 may be disposed along the first direction by repeating A1, A2, A1, and A3 in sequence, or may be disposed along the first direction by repeating A1, A1, A2, and A3 in sequence. Accordingly, a pattern in which an arrangement of auxiliary electrode pairs 123-1, 124-1, 125-1 and 126-1 may be disposed between an arrangement of main electrode pairs 121 and 122 may be repeated in the first direction, and the effect of improving the mechanical strength of the multilayer electronic component 100′ may be further improved.

A method for manufacturing a multilayer electronic component

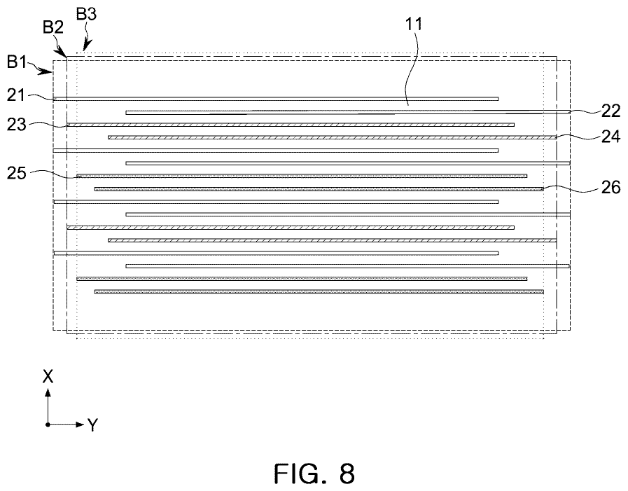

FIG. 8 schematically illustrates a portion of a method for manufacturing a multilayer electronic component according to an embodiment.

Hereinafter, a method for manufacturing the multilayer electronic component according to an embodiment will be described in detail with reference to FIG. 8.

A method for manufacturing the multilayer electronic component according to an embodiment may include a step of forming the body 110 including the dielectric layer 111 and two or more internal electrodes 121, 122, 123, 123-1, 124, 124-1, 125, 125-1, 126, and 126-1 alternately disposed with the dielectric layer 111 in the first direction and have different lengths in the second direction, perpendicular to the first direction.

In the step of forming the body 110, a step of printing conductive paste portions for the internal electrodes 21, 22, 23, 24, 25, and 26 including one or more of nickel (Ni), copper (Cu), palladium (Pd), silver (Ag), gold (Au), platinum (Pt), tin (Sn), tungsten (W), titanium (Ti) and alloys thereof on a dielectric sheet 11 formed using a dielectric slurry including a barium carbonate-based dielectric material and a plasticizer, and repeatedly stacking the same, may be performed.

The conductive paste portions for the internal electrodes 21, 22, 23, 24, 25, and 26 may be printed on the dielectric sheet 11 by a screen printing method or a gravure printing method, but the present disclosure is not limited thereto.

A plurality of dielectric sheets 11 and a plurality of conductive paste portions for internal electrodes 21, 22, 23, 24, 25, and 26 may form a multilayer through a laminate and compression process, and may be cut into a size corresponding to a multilayer electronic component during the process.

In the method for manufacturing the multilayer electronic component according to an embodiment, a main electrode pair and an auxiliary electrode pair may be formed by polishing opposing surfaces of a laminate in the second direction in which the dielectric sheet 11 and the internal electrode paste portions 21, 22, 23, 24, 25, and 26 are laminated.

Referring to FIG. 8, a surface of the laminate body may be determined as one of B1, B2 and B3 depending on the capacitance of the multilayer electronic component, and this may be controlled by polishing the surface on which the conductive paste portions for the internal electrodes 21, 22, 23, 24, 25, and 26 is exposed.

Specifically, when the surface of the laminate is determined as B1, conductive paste portions for internal electrodes 21 and 22 may be exposed to the surface of the laminate body, but conductive paste portions for internal electrodes 23, 24, 25, and 26 may not be exposed to the surface of the laminate body. In this case, the conductive paste portions for the internal electrodes 21, and 22 may form the main electrode pairs 121 and 122 later, the conductive paste portions for the internal electrodes 23, 24, 25, and 26 may form the auxiliary electrode pairs 123-1, 124-1, 125-1, and 126-1 later, and may correspond to a case of forming the internal electrodes 121, 122, 123-1, 124-1, 125-1, and 126-1 of the multilayer electronic component 100′ according to the modified example.

When the surface of the laminate is determined as B2, conductive paste portions for internal electrodes 21, 22, 23, and 24 may be exposed to the surface of the laminate, but conductive paste portions for internal electrodes 25 and 26 may not be exposed to the surface of the laminate. In this case, the conductive paste portions for the internal electrodes 21, 22, 23, and 24 may form the main electrode pairs 121, 122, 123, and 124 later, the conductive paste portions for internal electrodes 25 and 26 may form the auxiliary electrode pairs 125-1 and 126-1 later, and this may correspond to a case of forming the internal electrodes 121, 122, 123, 124, 125-1, and 126-1 of the multilayer electronic component 100 according to an embodiment.

When the surface of the laminate is determined as B3, all the conductive paste portions for the internal electrodes 21, 22, 23, 24, 25, and 26 may be exposed to the surface of the laminate, all the conductive paste portions for the internal electrodes 21, 22, 23, 24, 25, and 26 may form the main electrode pairs 121, 122, 123, 124, 125, and 126, and this may correspond to a case of forming a multilayer electronic component 10′ according to a conventional embodiment.

In this manner, in an embodiment, by polishing the surfaces opposing each other in the second direction of the laminate in which the main electrode pair and the auxiliary electrode pair are stacked with the dielectric sheet 11 and the conductive paste portions for the internal electrodes 21, 22, 23, 24, 25, and 26, various capacitances may be implemented in substantially the same size of the multilayer electronic component, and a mechanical strength of the multilayer electronic component may be improved by controlling the number of the auxiliary electrode pairs.

After the step of forming the laminate body, a process of forming a cover portion may be additionally performed as needed, and then the body 110 may be formed by sintering at a temperature of 900° C. to 1200° C.

After the step of forming the body 110, the external electrodes 130 and 140 may be formed on the body 110.

A method of forming the external electrodes 130 and 140 is not particularly limited. For example, an electrode layer that may be included in the external electrodes 130 and 140 may be formed by using a method of dipping into a paste including a conductive metal and a glass, or by transferring a sheet including a conductive metal. Additionally, it may be formed by using a paste containing a conductive metal and a resin, or by using an atomic layer deposition ALD method, a molecular layer deposition MLD method, a chemical vapor deposition CVD method, a sputtering method, or the like.

In addition, when a plating layer is disposed on the electrode layer, the plating layer may be formed by using a method such as an electrolytic plating method or an electroless plating method.

Although the embodiments of the present disclosure have been described in detail above, the present disclosure is not limited by the above-described embodiments and the accompanying drawings but is defined by the appended claims. Therefore, those skilled in the art may make various replacements, modifications, or changes without departing from the scope of the present disclosure defined by the appended claims, and these replacements, modifications, or changes should be construed as being included in the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including a dielectric layer and two or more internal electrodes alternately disposed with the dielectric layer in a first direction, the two or more internal electrodes having different lengths in a second direction, perpendicular to the first direction; and
external electrodes disposed on the body and connected to at least one of the two or more internal electrodes;
wherein the two or more internal electrodes include a main electrode pair connected to the external electrodes and disposed with the dielectric layer therebetween and an auxiliary electrode pair spaced apart from the external electrodes and disposed with the dielectric layer therebetween,
wherein each of the two or more internal electrodes have a continuous shape in the second direction.

2. The multilayer electronic component of claim 1, wherein the two or more internal electrodes include two or more pairs of the auxiliary electrode pairs, and
wherein the two or more pairs of the auxiliary electrode pairs are spaced apart from an adjacent external electrodes of the external electrodes in the second direction at different distances.

3. The multilayer electronic component of claim 2, wherein an absolute value of a difference in a distance between the two or more auxiliary electrode pairs and the adjacent external electrodes of the external electrodes in the second direction is 1μm or more.

4. The multilayer electronic component of claim 1, wherein an area where the main electrode pair overlaps to each other in the first direction is smaller than an area in which the auxiliary electrode pair overlaps to each other in the first direction.

5. The multilayer electronic component of claim 1, wherein the two or more internal electrodes include two or more pairs of the main electrode pairs and two or more pairs of the auxiliary electrode pairs, and
wherein the two or more pairs of the auxiliary electrode pairs are alternately disposed with the two or more of the main electrode pairs with the dielectric layer interposed therebetween.

6. The multilayer electronic component of claim 1, wherein the two or more internal electrodes include two or more pairs of the main electrode pairs and two or more pairs of the auxiliary electrode pairs spaced apart by different distances from the external electrodes,
wherein a configuration of the two or more pairs of the main electrode pairs is A1, a configuration of the two or more pairs of the auxiliary electrode pairs having the a minimum separation distance from first adjacent external electrodes is A2, and a configuration of the two or more pairs of the auxiliary electrode pairs with a maximum separation distance from second adjacent external electrodes is A3, and
the two or more internal electrodes are disposed in sequence as A1, A2, A1 and A3 along the first direction.

7. The multilayer electronic component of claim 1, wherein the two or more internal electrodes include two or more pairs of the main electrode pairs and two or more pairs of the auxiliary electrode pairs spaced apart at different distances from the external electrodes,
wherein a configuration of the two or more pairs of the main electrode pairs is A1, a configuration of the two or more pairs of the auxiliary electrode pairs having a minimum separation distance from first adjacent external electrodes is A2, and a configuration of the two or more pairs of the auxiliary electrode pairs having a maximum separation distance from second adjacent external electrodes is A3,
the internal electrodes are disposed in sequence as A1, A1, A2 and A3 along the first direction.

8. A method for manufacturing a multilayer electronic component, comprising:
forming a body including a dielectric layer, and two or more internal electrodes alternately disposed with the dielectric layer in a first direction and having different lengths in a second direction, perpendicular to the first direction; and
forming external electrodes disposed on the body and connected to at least one of the two or more internal electrodes,
wherein the two or more internal electrodes include a main electrode pair connected to the external electrodes and disposed with the dielectric layer therebetween, and an auxiliary electrode pair spaced apart from the external electrodes and disposed with the dielectric layer therebetween,
wherein the main electrode pair and the auxiliary electrode pair are formed by polishing opposing surfaces of a laminate body in the second direction, in which a dielectric sheet and internal electrodes paste are stacked.

9. The method of claim 8, wherein the two or more internal electrodes have a continuous shape in the second direction.

10. The method of claim 8, wherein the two or more internal electrodes include two or more pairs of the auxiliary electrode pairs,
wherein the two or more pairs of the auxiliary electrode pairs are spaced apart from an adjacent external electrode of the external electrodes in the second direction at different distances.

11. The method of claim 10, wherein an absolute value of a difference in a distance between the two or more of the auxiliary electrode pairs and the adjacent external electrode of the external electrodes in the second direction is 1 μm or greater.

12. The method of claim 8, wherein an area where the main electrode pair overlaps to each other in the first direction is smaller than an area where the auxiliary electrode pair overlaps to each other in the first direction.

13. The method of claim 8, wherein the two or more internal electrodes include two or more pairs of the main electrode pairs and two or more pairs of the auxiliary electrode pairs, and
wherein the two or more pairs of the auxiliary electrode pairs are alternately disposed with the two or more pairs of the main electrode pairs with the dielectric layer interposed therebetween.

14. The method of claim 8, wherein the two or more internal electrodes include two or more pairs of the main electrode pairs and two or more pairs of auxiliary electrode pairs spaced apart at different distances from the external electrodes,
wherein a configuration of the two or more pairs of the main electrode pairs is A1, a configuration of the two or more pairs of the auxiliary electrode pairs with a minimum separation distance from first adjacent external electrodes is A2, and a configuration of the two or more pairs of the auxiliary electrode pairs with a maximum separation distance from second adjacent external electrodes is A3, and
the internal electrodes are disposed in sequence as A1, A2, A1 and A3 along the first direction.

15. The method of claim 8, wherein the internal electrodes include two or more pairs of the main electrode pairs and two or more pairs of auxiliary electrode pairs spaced apart at different distances from the external electrodes,
wherein a configuration of the two or more pairs of the main electrode pairs is A1, a configuration of the two or more pairs of the auxiliary electrode pairs with a minimum separation distance from first adjacent external electrodes is A2, and a configuration of the two or more pairs of the auxiliary electrode pairs with a maximum separation distance from second adjacent external electrodes is A3, and
the internal electrodes are disposed in sequence as A1, A1, A2 and A3 along the first direction.
